(19) United States
(12) Patent Application Publication
(10) Pub. No.: US 2018/0351397 A1
(43) Pub. Date: Dec. 6, 2018

(54) IMPROVED ENERGETIC EFFICACY ELECTRICAL SYSTEM FOR GENERATING POWER TO RECHARGEABLE BATTERY FROM VERSATILE ENERGY SOURCES

(71) Applicant: Tanhum AHARONI, Nofim (IL)

(72) Inventor: Tanhum AHARONI, Nofim (IL)

(21) Appl. No.: 15/572,105

(22) PCT Filed: May 7, 2015
(86) PCT No.: PCT/IB2015/053322

§ 371 Date: Nov. 6, 2017

(51) Int. Cl. H02J 7/14; H02J 3/38; H02J 7/02; H02J 7/00; B60L 11/18

(52) U.S. Cl. CPC H02J 7/1423; H02J 3/385; H02J 3/386; H02J 7/027; H02J 2007/143; B60L 11/1861; H02J 2007/0037; B60L 2210/40; H02J 7/0047

(57) ABSTRACT

A improved energetic efficacy electrical system is described, including at least one supplemental rechargeable battery; an electric motor; an electromagnetic generator and DC-AC-DC converter/inverter. The supplemental rechargeable battery is in electric communication with the DC-AC-DC converter/inverter, whereas the DC-AC-DC converter/inverter is in electric communication with the electric motor.

### TECHNICAL FIELD

The present invention pertains to recharging batteries using an improved energetic efficacy electrical system harvesting energy converted from sources independent of or recycled from an operating electric device. Particularly, the present invention pertains to rechargeable batteries that are recharged using improved energetic efficacy electrical system operated with a rechargeable battery, where the recharging of both batteries is made with electrical, natural and mechanical energy sources.

### BACKGROUND

Electromagnetic generators are widely used to recharge batteries due to their capability to produce high output relative to the input required to start them up. Such generators are integrated within electric motors in different applications, particularly in electric and non-electric motor vehicles. However, the generators in such applications need to be excited by electric current produced by the motor itself or the electricity grid, thus lowering the efficiency of such closed circle or external electrical source-depended recharging. This co-dependency between generator and motor is aggravated particularly when the motor is turned off, not providing the energy to startup the generator for charging the battery. As a result, the battery is gradually depleted off of the electric charge it stores, resulting eventually in zero or very low current produced, which might be insufficient to turn on the electric appliance in the next cycle of operation.

Partial solution is provided by back-up or duplicated system containing batteries and generators configured to recharge the batteries and operate motors in turns (see, for example, US 2012/01651564).

In another aspect, attempts to solve the problem of relying on the electricity grid and fossil, gas or coal energy sources for starting up engines and recharging batteries is currently partially solved by interfacing with natural or secondary energy sources, such as wind, light, heat and mechanical movement. Accordingly, systems like solar panels, wind turbines and mechanical and heat recycling means are mounted on electrically operated machines, supplementing them with additional electric charge. These systems are particularly beneficial in providing additional power required to operate machines relying on electricity. Such system, however, feed directly the main battery of the machines, e.g. cars, which turns to be inefficient in certain cases, particularly, with batteries having large capacity. See for example, U.S. Pat. No. 8,646,550, U.S. Pat. No. 8,434,547, U.S. Pat. No. 7,540,346, U.S. Pat. No. 6,857,492, U.S. Pat. No. 5,291,960, U.S. Pat. No. 4,254,843, CN 101941519, CN 102120423 and CN 103241126).

Yet it is another object of the present invention to provide partially or entirely electrically operated system with integrated collectors for recharging main battery of the system.

Yet it is another object of the present invention to provide partially or entirely electrically operated system with means for converting and recycling natural and secondary energy to electricity, feeding the main battery directly or indirectly.

Yet it is another object of the present invention to provide a method for indirect recharging of a main battery of partially or entirely electrically operated system using improved energetic efficacy electrical system with a rechargeable supplemental battery.

### SUMMARY

In one aspect, the present invention provides an improved energetic efficacy electrical system operated with a supplemental rechargeable battery and connected to rechargeable main battery on the output for recharging from external and internal energy sources on the input for recharging the main and supplemental batteries.

In still another aspect, of the present invention is an independently operated supplemental battery that is rechargeable from natural energy sources, for example wind, light and water wave movement and internal sources, for example kinetic energy produced by mechanical operation of the device within which the generator unit is integrated. This configuration is beneficial for several reasons: First, the supplemental battery generally has smaller capacity than the capacity of the main battery of the device and is, therefore, charged in a shorter amount of time and can be removable. Second, the electric charge in the supplemental battery that is in part of the generator unit is sufficient to operate the motor for a longer period of time. Thus, the external and internal energy sources are more efficiently exploited to recharge a supplemental battery of a device in contrast to direct charging of the main battery.

Accordingly, the improved energetic efficacy electrical system of the present invention provides the advantage of more efficient use of external and internal energy sources by indirect conversion of energy to power by recharging relatively small capacity battery.

It should be noted that the efficient use of energy input in recharging batteries of electric machines and devices is also based on the speed of recharging the supplemental batteries, which depends also on their capacity. Relatively small capacity of the supplemental batteries translates to their faster complete recharging. Therefore, in one particular embodiment, the capacity of the supplemental batteries is significantly smaller than the capacity of the main battery of an electric machine or device.

In another particular embodiment, the ratio between the capacity of the supplemental batteries and the capacity of the main battery is set to recharge the supplemental batteries to full capacity in a period of time that is a pre-selected fraction of the period of time to recharge the main battery. This ratio depends of course on the power consumption of the particular machine or device, so that the main battery will always provide it the sufficient power to operate.

Particular, non-limiting example of supplemental and main batteries capacity is 3 and 8 Watts, respectively.

In still another aspect, of the present invention recharge the main battery from the external and internal sources, in any case, e.g. clouds, night time, still air, parked vehicle and absence of connection to the grid. This is enabled due to recharging the supplemental battery from external and internal energy sources, which allow operating independently.

Another advantage of the present invention is in maintaining minimum charge in the main battery at all times and independently of the external and internal energy sources. This is made possible since the supplemental rechargeable battery/batteries store sufficient power to operate the starter motor, which needs much less electrical energy relative to start the engine.

One other advantage of the generator unit is that the supplemental and main batteries can discharge right back to the grid in case of overflow production of power in the device. This benefits the owner of the device with credits for the power supplied back to the power company and the power company enjoys the supplemental power input.

It should be noted that the generator unit of the present invention is configured to be installed in and adapted to various partially or entirely electrically operated devices. In particular, the generator unit is configured to be installed in fully or partially electrically operated land, airborne and marine vehicles and power consuming factories located in proximity to natural energy sources, e.g. waterfalls, open areas exposed to solar radiation or intense wind regime.

The following describes a particular configuration of an improved energetic efficacy electrical system, applicable for recharging main battery in partially or entirely electrically operated devices and machines. This particular configuration is in accordance with FIGS. 2 and 3 as detailed later in the description:
1. At least one supplemental battery;
2. Motor operating electromagnetic generator; and
3. DC-AC-DC converter/inverter.

The supplemental battery/batteries are charged from external and internal, electrical and non-electrical sources, using energy collectors such as solar panels, wind turbines, mechanical parts of the device producing kinetic energy and electrical grid as shown in FIG. 1.

One or more of additional functional parts may be added to the basic configuration of the generator unit described above as follows:
4. Sensors for detecting current capacity in the main and supplemental batteries.
5. Switching controller operated automatically by the sensors to connect the main and supplemental batteries for re-charging.
6. Electrical loads, such as light bulbs, electric motor, fan, air-conditioner and electrically operated windows etc. connected to the generator unit.

In one particular embodiment, the controller and the converter/inverter provide constant current through the generator unit energy. Further, the supplemental batteries provide current as required once the controller determines there is enough charge in the supplemental batteries to operate the motor and generator. Additionally, when the converter/inverter sensors in the generator unit detect a need for additional current, the generator unit automatically connects the supplemental batteries for the purpose of recharging the main battery as necessary. In another optional application, the controller and converter/inverter provide constant current from the energy generated by the generator unit to keep a minimal charge in the main battery. The sensors essentially determine the battery switching according to measurement of pre-determined charge that should be stored in the main battery.

The generator unit also has a regulation component and means to protect against over charging, short circuits, excessive loads, etc.

The generator unit controller and sensors make it possible for the generator unit to regulate and switch the supplemental batteries to be connected and not connected to the generator in accordance with the capacity required and the electrical loads connected to the main battery. Further, in accordance with one optional implementation of the present invention, real-time data concerning the functioning of the generator unit and capacity are collected using the appropriate software and displays.

In still another particular embodiment, the generator unit comprises further components as follows:
1. Transformer with current regulator and a voltage output regulator.
2. Mechanical drive connection between the generator and the motor.
3. Manual and automatic operating switches.
4. Load indicators.
5. Collar for the motor.
6. UPS for an independent electrical device, not connected to the electric vehicle motor.
7. Software to provide remote monitoring of system data.

In still another particular embodiment, the generator unit is used to power electrical or hybrid, i.e. vehicles operating on electrical batteries and gas engines, and industrial and domestic machines, applications and appliances.

In one aspect, the process for the generation of electrical energy and recharging main battery of electrically operated device with the improved energetic efficacy electrical system of the present invention comprises:
1. Receiving energy input from external and internal, electrical and non-electrical, energy sources in the generator unit;
2. Operating a motor;
3. Activating an electromagnetic generator; and
4. Recharging a main battery of an electrical motor, machine or device in communication with the generator unit or in which the generator unit is integrated with the power produced by the generator.

In particular, the energy input from the external and internal energy sources operates a mechanical pulley arrangement in the DC motor of the generator unit, which is translated to AC current generated in the electromagnetic generator. The AC current flows to a DC-AC-DC converter/inverter to recharge the supplemental batteries. In the reverse operation, the generator unit recharges a main battery of the electric machine or device by discharging the supplemental batteries through the DC-AC-DC converter/inverter that operates the DC motor and the pulley arrangement. The DC motor then activates the electromagnetic generator that generates AC current, which flows through the converter/inverter. The converter/inverter then redirects the DC current to the main battery and recharges it.

The two processes of recharging the supplemental and main batteries may take place simultaneously or concurrently according to appropriate configuration within the generator unit and current flow between the unit components. In one particular embodiment, the current flow within the generator unit is monitored by sensors receiving indication on the batteries charging state and operating switches redirecting the current according to a desired level of charge. Optionally, the sensors and switches in the generator unit keep a certain level of charge in the main battery, which is sufficient to activate an electric motor of a device or machine after shut off. In another embodiment, the sensors and switches control the generator unit output and input current to keep maximum recharging of the supplemental batteries and minimum recharging of the main battery.

In still another particular embodiment, the operation of the electromagnetic generator recharges the main battery directly from the external and internal energy sources through the DC motor. Accordingly, a pre-programmed switch monitors and controls the split of input energy between the main and supplemental batteries. This direct dual recharging benefits by avoiding one stage of recharging and discharging the supplemental batteries and still maintaining sufficient charge in them to recharge a depleted main battery in situations of zero or insufficient flow of energy to the generator unit.

In one particular embodiment, the present invention pertains to a generator unit that comprises:
1. Electromagnetic generator receiving direct current, and outputting alternating current to converter/inverter for recharging main and supplemental batteries;
2. DC-AC-DC converter/inverter at the input and output of the generator and output and input of the supplemental battery/batteries.
3. Clutch at the output of the generator configured to allow or block electric current flow to and recharging of a main battery.
4. Supplemental rechargeable battery/batteries with input connection to external and internal, natural and self-circulating energy sources and input/output connection to the DC-AC-DC converter/inverter.

In another particular embodiment, the generator unit further comprises:
5. Controller, preferably MPPT (Maximum Power Point Tracker), that controls the interface with natural and recycled energy sources collectors. In particular, such collectors are selected from solar panels, wind turbines and means for converting mechanical, namely kinetic, energy to power mounted on an electrical device.

In one particular implementation of the generator unit in an electrical vehicle, PMG (Permanent Magnet Generator) units are installed on the axles between each pair of wheels, and which are similar to the generator unit of the present invention. Each PMG translates the kinetic energy of the mechanical movement of the wheels and axles to electric charge that flows to the generator unit that is in communication with the main battery of the vehicle.

It should be noted that the improved energetic efficacy electrical system may recharge the main and supplemental batteries also when the electric machine or device are operating. Appropriate indicators communicate the status of the main and supplemental batteries to the operator. Particularly, LEDs (Light Emitting Diode) are used, for example, to inform a driver of a vehicle on the status of the batteries. The same LEDs may also alarm the driver in situations of low batteries, main or supplemental, for example by flashing or changing color. Other modes of alarm, e.g. audio, other forms of more informative visual display, may be used for the same purpose. In particular, a microprocessor may be used to continuously process updated information from the generator unit and batteries and transmit them to visual display or human/machine speaker.

The improved energetic efficacy electrical system of the present invention is essentially not limited to the number of phases used for alternating current fed to the generator. Therefore, single, two, three or six phase AC input/output current may be used in operating the generator. This may be controlled with the microprocessor controlling also the indicators of generator unit.

In one optional application, the improved energetic efficacy electrical system may be any electromagnetic generator recharging a main battery of an electric machine or device. The generator may also provide current to the main battery at a variety of voltages, e.g. 120 V, 220 V and 240 V.

The improved energetic efficacy electrical system of the present invention may also monitor and control the length of time period for recharging the batteries in order not to overheat them. Accordingly, appropriate automatic periods of time of operation may be set and controlled by a controller at the input and output of the generator unit. Thus, control on energy flow in and out of the generator unit is obtained. In addition, a sensor that constantly measures the charging state of the main battery may be placed between this controller and the main battery and signal the controller when that charging state reaches a minimum level of depletion, maximum level of charging or any selected optimal level of charging of the main battery. The controller will respond accordingly and command the generator unit to stop or restart the recharging of the main battery.

Finally, the supplemental and main batteries may be selected from any type of rechargeable batteries. Particularly, lead-acid, nickel cadmium, nickel metal hydride, potassium ion, lithium ion, thin film lithium sulfur, lithium ion polymer, carbon foam and smart battery types of rechargeable batteries may be used in the present invention for the main and supplemental batteries.

The following relates to the accompanying Figures without departing from the spirit of the invention as detailed above.

### BRIEF DESCRIPTION OF THE DRAWINGS

FIG. 1 illustrates schematic presentation of generator unit integrated within a vehicle.

FIG. 2 illustrates a particular configuration of a generator unit for generating and outputting power to main battery.

FIG. 3 illustrates a current converter in the generator unit for the supply of electricity fed internally in accordance with the present invention.

FIG. 4 is a schematics illustration of a generator unit recharging from and discharging to the grid.

### DETAILED DESCRIPTION OF THE DRAWINGS

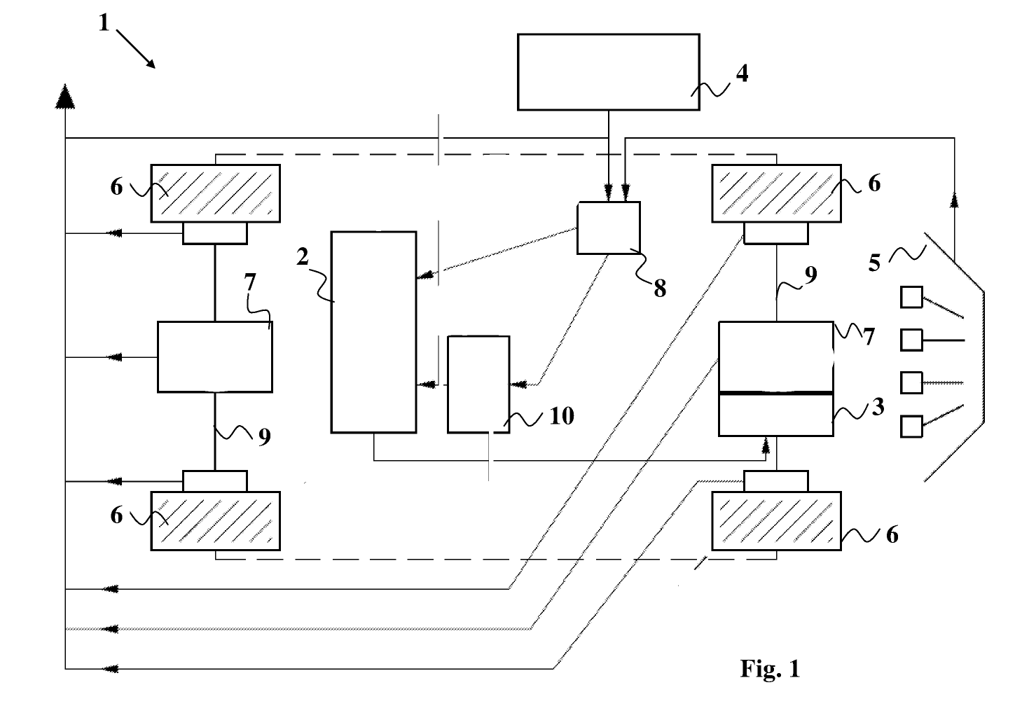

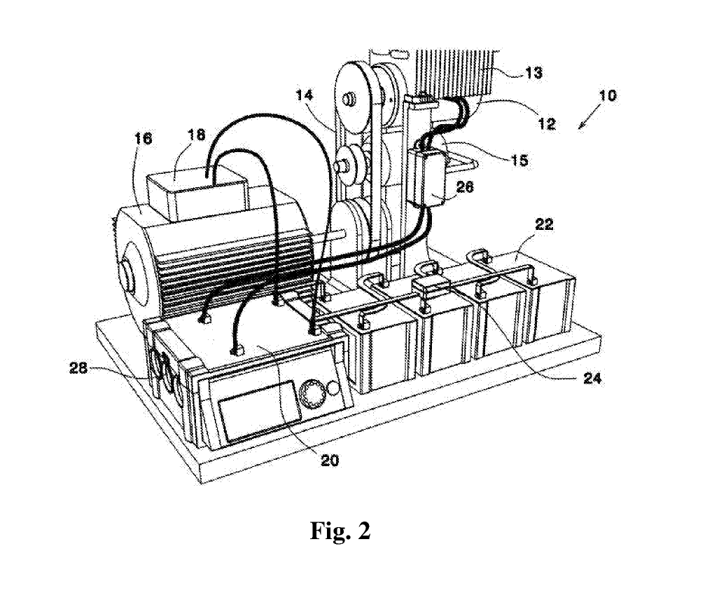

FIG. 1 schematically illustrates a particular application of a generator unit of the present invention integrated within a vehicle (1). MPPT controller, inverter and AC charger (8) are in direct communication with the generator unit (10), through which the generator unit (10) is fed with energy collected with different collectors. Solar panels (4), appropriately installed and or hidden in the vehicle (1), turbine winds (5) and PMG generators (7) are connected to the MPPT controller (8) that controls the flow of energy from them to the generator unit (10) and to the main battery (2). PMG generators (7) are installed on the axles (9) between each pair of wheels (6), moving in concert with the movement of the wheels and translating their kinetic energy to electrical current, which then flows to the generator unit (10) through the inside inverter/controller (20) as shown in FIG. 2. The output of the generator unit (10) communicates with the main battery (2), recharging it with the power generated. The communication between the generator unit (10) and the main battery (2) is controlled with a clutch that activates recharging when the vehicle is in parked state or when the capacity of the main battery (2) is low.

FIG. 2 illustrates a particular type of generator unit (10) that may be integrated within any electrically operated application for recharging main battery (2) as shown in FIG. 1. The generator unit (10) for the recharging of main battery (2) (see FIG. 1) comprises: supplemental batteries (22) powering electric motor (12) that drives electromagnetic generator (16) via a pulley arrangement comprising a belt (14). DC motor (15) is used to operate the motor and cooler (13) expels extra heat generated in the operation of the motor (12). Automatic regulator (26) adjusts the supply for the motor voltage (12). Supplemental batteries (22) are charged and recharged from energy sources external and internal to the application, natural, electrical or recycled (as shown in FIG. 1), and output current to motor (12), which then powers generator (16). The current generated by the generator (16) flows to the controller (20) at a current speed determined by rotation speed (18), and from there it recharges main battery (2) (shown in FIG. 1). The charge in supplemental batteries (22) flows through switching and measuring means (24) that monitor and redirect the current flow to and from the current converter/inverter (20), which will supply output to the main battery (2). The converted current enters a transformer equipped with an automatic regulator (Variac) before it enters the main battery (2).

Electric sockets (28) fitted onto the current converter/inverter (20) can be used to discharge batteries (22) back to the grid and be credited for the extra power provided to the electricity company. Otherwise, the converter/inverter (20) continues to stream current to the main battery (2) to recharge it.

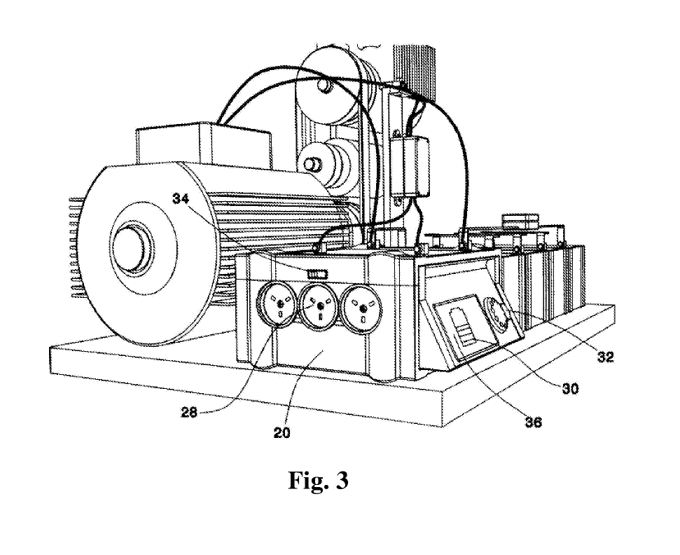

For generator unit (10) connected to electrical applications, appliances, machines or devices and viewable to a user, as shown in FIG. 3, the current converter/inverter (20) comprises: a screen (36) displaying battery power (30), an ON/OFF switch (32), which turns the unit on and off and a button (34), which supplies voltages from 0 to 230 volts through the socket (28).

When the start up of the generator unit (10) for recharging a main battery is required, the current converter/inverter (20) is turned on. The current converter/inverter (20) receives electrical current from the supplemental batteries (22). The current flows through the current switching and measuring systems (24), through the transformer and on into the motor (12) which then rotates. As in the example in FIG. 2, the motor (12) drives the generator (16) to which it is permanently connected and which generates current that recharges main battery (2) and eventually operates a load fed from the main battery (2), e.g. motor of a vehicle, electrically based system in a vehicle such as air-conditioning, electrical windows, fan etc.

The connection between the motor and the generator can be made using belts, gear wheels or using a direct mechanical connection.

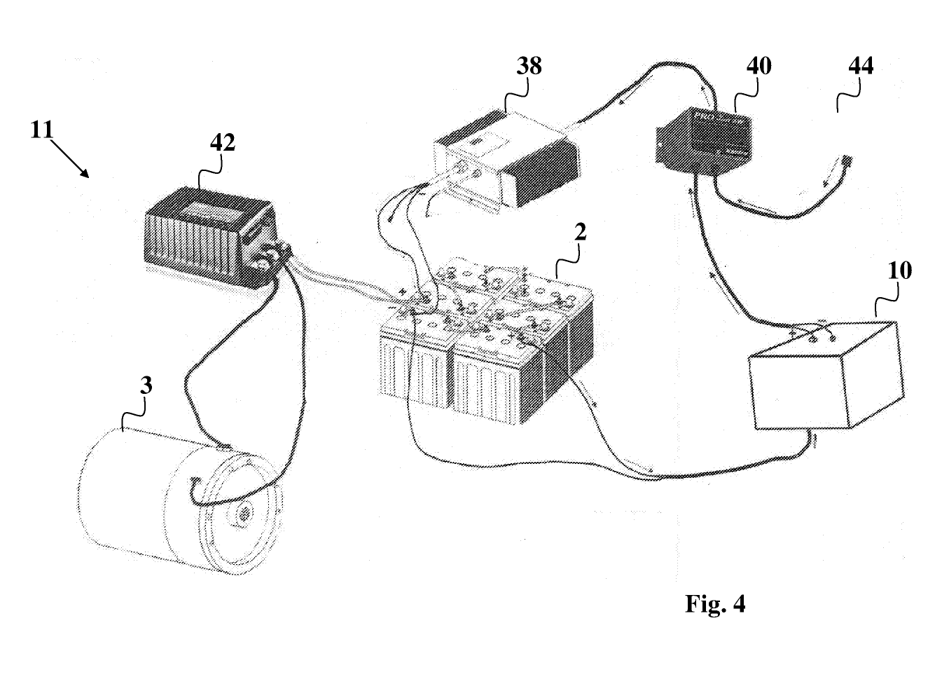

Finally, FIG. 4 illustrates schematics (11) of a generator unit of the present invention connected to an electricity grid (44). This particular configuration illustrates the two modes of recharging and discharging main battery (2) of any electric device or machine from and to the grid (44), respectively. The recharging mode shows that the battery (2) is recharged directly from the grid (44) through relay box (40) and AC charger (38). Motor (3) activates controller (42) that monitors the charging state of the battery (2) and controls its capacity. Accordingly, the controller may be set to stop recharging upon reaching maximum capacity of the battery (2). In the reverse mode of discharging, the main battery (2) is indirectly discharged to the grid (44) through reverse action in generator unit (10) through converter/inverter (20) and DC motor (12) (shown in FIG. 2), which is in electric communication with the grid (44). Motor (3) activates controller (42) that switches to discharge mode and initiates command to depleting battery (2) through generator unit (10). Controller (42) also controls and monitors the minimum depletion state of the battery (2) and stops discharging when minimum charge to be kept in the battery (2) is reached.

In view of the illustration in FIG. 4, the present invention provides a method of discharging the main rechargeable battery (2) of partially or entirely electrically operated machine, device, application or appliance to an electricity grid (44) that comprises:
1. operating the motor (3) of the machine, device, application or appliance;
2. activating controller (42) of the machine, device, application or appliance with the motor (3), where the controller (42) is in electric communication with the motor (3);
3. discharging the main battery (2) of the machine, device, application or appliance through DC-AC-DC converter/inverter (20) in the generator unit (10), where the generator unit (10) is in electric communication with the main battery (2);
4. activating DC motor (12) of the generator unit (10), where the DC motor (12) is in electric communication with the electricity grid (44);
5. activating the controller (42) to monitor discharging of the main battery (3); and
6. activating the controller (42) to stop discharging of the main battery (2) upon reaching minimum charge state in the main battery (2).

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. An improved energetic efficacy electrical system for generating power to a rechargeable battery from versatile energy sources, said system comprises:
(a) at least one supplemental rechargeable battery;
(b) an electric motor;
(c) an electromagnetic generator;
(d) a DC-AC converter/inverter;
(e) at least one photovoltaic cell;
(f) at least one wind turbine;
wherein said at least one supplemental rechargeable battery is in electric communication with said DC-AC converter/inverter and said electromagnetic generator is in electric communication with said DC-AC converter/inverter and operationally connected to a wheals shaft;
wherein said improved energetic efficacy electrical system is in input communication with energy sources, said energy sources are selected from:
external natural energy sources and internal sources of energy recycled within said system,
wherein said improved energetic efficacy electrical system is in output communication with a main rechargeable battery of an electric appliance.

2. The improved energetic efficacy electrical system of claim I., further comprises:
(a) a sensor for detecting current capacity in said supplemental rechargeable batteries;
(b) a switching controller configured to operate automatically by said sensors to connect said supplemental rechargeable batteries for recharging; and
(c) at least one electrical load in communication with said generator unit.

3. The improved energetic efficacy electrical system of claim 2, wherein said at least one electrical load is selected from: light bulbs, electric motor, fan, air-conditioner and electrically operated windows.

4. The improved energetic efficacy electrical system of claim 1 further comprises:
(a) a transformer with current regulator and a voltage output regulator;
(b) a mechanical drive connection between said electromagnetic generator and said electric motor;
(c) a manual and automatic operating switch;
(d) a load indicator;
(e) a collar for said electric motor;
(f) a UPS for an independent electrical device, not connected to the electric vehicle motor; and
(g) a software to provide remote monitoring of generator unit.

5. The improved energetic efficacy electrical system of claim 1, further comprising MPPT (Maximum Power Point Tracker) configured to control an interface with collector of said natural and recycled energy sources.

6. The improved energetic efficacy electrical system of claim 5, wherein said collectors of energy are selected from: solar panels, wind turbines and means for converting mechanical energy to power mounted on an electrical device.

7. The improved energetic efficacy electrical system of claim 1, wherein said external electric source is electricity grid.

8. The improved energetic efficacy electrical system of claim 1 further comprises a regulation component and means to protect against over-charging, short circuits and excessive loads.

9. The improved energetic efficacy electrical system of claim 1, wherein said generator unit is in communication with indicators communicating status of said main and supplemental rechargeable batteries to an operator of said machine, device, application or appliance, said indicators are selected from LED, visual display screen and audio human or machine announcements.

10. The improved energetic efficacy electrical system of claim 1, configured for single, two, three or six phase AC input/output current.

11. The improved energetic efficacy electrical system of claim 1, wherein said electromagnetic generator is configured to provide current to said main rechargeable battery at 120 V, 220 V or 240 V.

12. The improved energetic efficacy electrical system of claim 1, further comprises a controller for monitoring and controlling the length of time period for recharging said main and supplemental rechargeable batteries.

13. The improved energetic efficacy electrical system of claim 12, further comprises a sensor between said main battery and said controller, said sensor constantly measuring a charging state of said main battery and signaling said controller when said charging state reaches a minimum level of depletion, maximum level of charging or any selected optimal level of charging of said main battery, wherein said controller responding to said signaling of said sensor and commanding said generator unit to stop or restart recharging of said main battery.

14. The improved energetic efficacy electrical system of claim 1, wherein capacity of said supplemental batteries is smaller than capacity of said main battery of said electric appliance.

15. The improved energetic efficacy electrical system of claim 14, wherein said capacity of said supplemental batteries is at least it sufficient to operate said generator of said generator unit continuously to recharge said main battery and keep a minimum charge in said main battery or recharge said main battery in a depleted condition to as least said minimum charge.

16. The improved energetic efficacy electrical system of claim 1, wherein a ratio between capacity of said supplemental batteries and capacity of said main battery is set to recharge said supplemental batteries to full capacity in a period of time that is a pre-selected fraction of a period of time to recharge said main battery.

17. The improved energetic efficacy electrical system of claim 14, wherein said capacity of said supplemental batteries is 3 Watts, whereas said capacity of said main battery is 8 Watts.

18. The improved energetic efficacy electrical system of claim 1, wherein said main and supplemental rechargeable batteries are selected from lead-acid, nickel cadmium, nickel metal hydride, potassium ion, lithium ion, thin film lithium sulfur, lithium ion polymer, carbon foam and smart battery types.

19. An electric vehicle comprises:
an improved energetic efficacy electrical system comprising:
(a) at least one modular and detachable supplemental rechargeable battery;
(b) an electric motor;
(c) an electromagnetic generator;
(d) a DC-AC converter/inverter;
(e) at least collector;
wherein said at least one supplemental rechargeable battery is in electric communication with said DC-AC converter/inverter and said electromagnetic generator is in electric communication with said DC-AC converter/inverter and operationally connected to axles between at least one pair of wheels of said vehicle;
wherein said improved energetic efficacy electrical system is in input communication with energy sources, said energy sources are selected from:
external natural energy sources and internal sources of energy recycled within said system;
wherein said improved energetic efficacy electrical system is in output communication with a main rechargeable battery of an electric appliance.
wherein a controller configured to control the interface with collector of natural and recycled energy sources;
wherein said collectors of energy from natural and recycled energy sources selected from:
(i) solar panels hidden in and integrated with said vehicle;
(ii) wind turbines set; and
(iii) PMG generators installed on axles between at least one pair of wheels of said vehicle;
wherein said improved energetic efficacy electrical system is in input communication with said collectors of energy;
(f) a rechargeable main battery, wherein said improved energetic efficacy electrical system is in output communication with said rechargeable main battery;
configured to generate electric energy into said at least one modular and detachable supplemental rechargeable battery when said vehicle is in parking state.
